(19) United States
(12) Patent Application Publication
(10) Pub. No.: US 2007/0024012 A1
(43) Pub. Date: Feb. 1, 2007

(54) Percussion tool chuck with a retaining stirrup

(75) Inventors: Stefan Hammerstingl, Munich (DE); Uto Plank, Freising (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 11/494,333

(22) Filed: Jul. 26, 2006

(30) Foreign Application Priority Data
Jul. 28, 2005 (DE) 10 2005 000 098.3

(51) Int. Cl. B23B 31/00

(52) U.S. Cl. 279/19.1

(57) ABSTRACT

A chuck for a mechanized, at least partially percussively driven, along a percussion axis (A), percussion tool (2), includes a tool guide (3), a retaining stirrup (5) having at least one stirrup arm (6) which is supported in a drag bearing (7) for a pivotal movement about a pivot axis (S) extending transverse to the percussion axis (A) and at least one elastomeric insert (B) provided between the tool guide (3) and the retaining stirrup (5).

### BACKGROUND OF THE INVENTION

1. Field of the Invention

The present invention relates to a chuck with a retaining stirrup for a mechanized, at least partially percussively driven percussion tool such as a percussion chisel.

2. Description of the Prior Art

Usually, percussion tools of an upper working range have, in the region of a shank end which is subjected to impacts, a radially extending retaining band. Associated chucks have displaceable retaining means that at least partially engages, at a percussion tool side of a chuck, from behind the retaining band, thus preventing an inadvertent loss or falling of the axially reciprocating percussion tool out of the chuck. In case of an idle impact, the retaining means should almost completely absorb and dissipate the impact energy transmitted to the percussion tool.

The retaining means, which engages from behind, at the percussion tool side of a chuck, the retaining band, are roughly divided, in eccentrically rotatable retaining levers, e.g., disclosed in U.S. Pat. No. 4,614,241, radially opening retaining sleeves, e.g., disclosed in U.S. Pat. No. 3,525,531 or French Patent No. 2,364,744, and retaining stirrups pivotal out of the percussion axis which are pivotally secured on the chuck with one or two stirrup arms, e.g., disclosed in U.S. Pat. No. 1,719,079, German Patent No. 285,863 or U.S. Pat. No. 2,604,328. The present invention is limited to chucks with retaining stirrups of the type discussed immediately above.

According to U.S. Pat. No. 2,604,328, such a chuck has a tool guide and a retaining stirrup with two stirrup arms. The stirrup is pivotable out of the percussion axis by 90°. The locking or retaining position, which is defined by the retaining stirrup pivotable along the percussion axis, is determined by stop means associated with respective stirrup arms. The retaining stirrup itself, which engages, at the working tool side of the chuck, from behind the retaining band, is resiliently connected with the chuck by spiral springs associated with respective stirrup arms.

Further, known is a damping action of materials with substantially imaginary component of a complex modulus of elasticity, which is determined for plastics approximately according to a temperature-and frequency-dependent WLF (Williams, Landel, and Ferry) equation which describes the dissipating loss portion of molecular relaxation processes.

An object of the present invention is to provide a chuck with a retaining stirrup for a percussion tool which can be produced in a technologically simple manner.

Another object of the present invention is to provide a chuck with a retaining stirrup that would insure an optimal damping of idle impacts.

### SUMMARY OF THE INVENTION

These and other objects of the present invention, which will become apparent hereinafter, are achieved by providing a chuck for a mechanized, at least partially percussively driven, along a percussion axis, percussion tool, and including a tool guide, a retaining stirrup having at least one stirrup arm, a drag bearing for supporting the retaining stirrup for a pivotal movement about a pivot axis extending transverse to the percussion axis, and at least one elastomeric insert provided between the tool guide and the retaining stirrup.

The elastomeric insert, which is provided between the tool guide and the retaining stirrup, elastically connects the two parts. Thereby, a chuck with a retaining stirrup, which reliably absorbs the impact energy of the idle impact, in particular in the retaining position, can be realized in a technologically simply manner. In particular, other components, such as springs, can be eliminated.

Advantageously, the elastomeric insert is formed of a material that has a maximum of the imaginary component of a complex modules of elasticity in the temperature range between O° C. and 70° C. and in the frequency range between 1 Hz and 100 Hz. This material permits to achieve an optimal damping in the determined insertion region.

Advantageously, the elastomeric insert is formed of abrasion-proof and wear-resistant material, which permits to achieve an extended service life even at high temperatures. The material is advantageously selected from a group of materials consisting of hydrogenated nytril-rubber (HNBR), ethylene-propylene-dien-rubber (EPDM), nytril-butadien-rubber (NBR), flouro-rubber (FPM), flouro-carbon-rubber (FKM) or polychlor-pren rubber (CR).

Advantageously, the elastomeric insert has a shape of sleeve or pot, forming an inner cylindrical surface. Thereby, a cylindrical bearing pin of the drag bearing is elastically supported therein with a possibility of a pivotal movement relative thereto.

Advantageously, the inner cylindrical surface is formed within a flat slide flange surface that extends transverse to the pivot axis. Thereby, the pivotal stirrup arm slides, at least partially, therealong upon being pivoted, with the friction therebetween breaking the pivotal movement. Advantageously, the stirrup arm is preloaded against the slide flange surface under pressure, e.g., as a result of being screwed, along the pivot axis of the drag bearing pin, to the elastomeric insert, which increases sliding and static friction forces.

Advantageously, there is provided, in the slide flange surface, at least one, preferably, several discrete stop recesses into which associated stop means of the stirrup arm can fittingly engage. Thereby, an advantageous pivot position, preferably, the locking position can be retained as a result of formation of at least partially formlocking connection.

Advantageously, the stop recess is formed as an elongate groove, preferably, as an inner wedge groove the longitudinal direction of which runs through the pivot axis. This insures optimal stoppage of an associated elongate stop means formed along the stirrup arm.

Advantageously, there are provided at least two elongate grooves offset relative to each other in their longitudinal direction at an angle in a range between 20° C. and 70° C., preferable, at an angle of 25° C. This insures a bi-stable or multi-stable stoppage of the retaining stirrup in ergonomically favorable positions.

Advantageously, the stop means is formed as a projection, preferably as a wedge-shaped projection that extends along the stirrup arm in the direction of the slide flange surface of the elastomeric insert, which insures an optimal stoppage of the stirrup arm.

Advantageously, the retaining stirrup has two spaced from each other and extending parallel to each other, stirrup arms each of which is associated with an elastomeric insert. Thereby, a symmetrical attachment of the retaining stirrup with the two stirrup arms is realized. In addition, the elasticity of the retaining stirrup insure a technologically simple preloading under pressure of the stirrup arms against the associated slide flange surface.

Advantageously, the tool guide has an elongate opening for each stirrup and which extends along the percussion axis. Thereby, a pivot support pin, which is elastically supported by the elastomeric insert and which extends along the pivot axis and into the tool guide, is capable of a limited axial movement.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1a a longitudinal cross-sectional view along line IA-IA in FIG. 2 of a chuck according to the present invention for a percussion tool;

FIG. 1b a longitudinal cross-sectional view along line IB-IB in FIG. 1 of a chuck according to the present invention for a percussion tool;

FIG. 2a a front view of an elastomeric insert for the chuck shown in FIGS. 1a-1b;

FIG. 2b a cross-sectional view along line II-IIB in FIG. 2a; and

FIG. 3 a cross-sectional view along line III-III in FIG. 1b of a stirrup arm of a retaining stirrup of the inventive chuck.

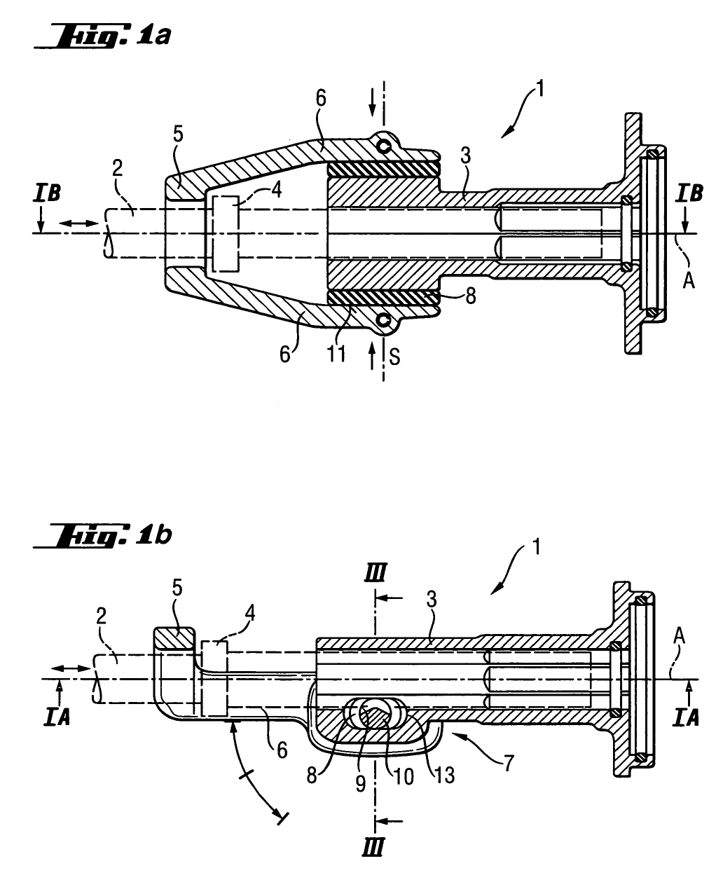

### DETAILED DESCRIPTION OF THE PREFERRED EMBODIMENTS

A chuck 1 according to the present invention for receiving a mechanized percussion tool 2 that is percussively driven along a percussion axis A and is shown only schematically, has a tool guide 3 and a U-shaped retaining stirrup 5 which is shown in its retaining position and which partially engages, at a percussion tool side of the chuck 1, from behind, a retaining band 4 of the percussion tool 2. The retaining stirrup 5 has two stirrup arms 6. The retaining stirrup 5 is supported in a drag bearing 7 for a pivotal movement about a pivot axis S extending transverse to the percussion axis A. The retaining stirrup 5 is secured in its retaining position. In order to provide for elastic connection between the tool guide 3 and the retaining stirrup 5, an elastomeric insert 8, which is formed of a hydrogenated nytril-rubber (HNBR) is provided in each of the stirrup arms 6. The elastomeric insert 8 forms a sleeve-shaped inner cylindrical surface 9. A cylindrical bearing pin 10 of the drag bearing 7 is elastically and pivotally arranged within the cylindrical inner surface 9. The inner cylindrical surface 9 is formed with a flat slide flange surface 11 that extends transverse to the pivot axis S. The stirrup arms 6 are preloaded, under pressure, against the slide flange surface 11 due to the stiffness of the retaining stirrup 5. The piston guide 3 has an elongate opening 13 extending along the percussion axis A and associated with the drag bearing pin 10.

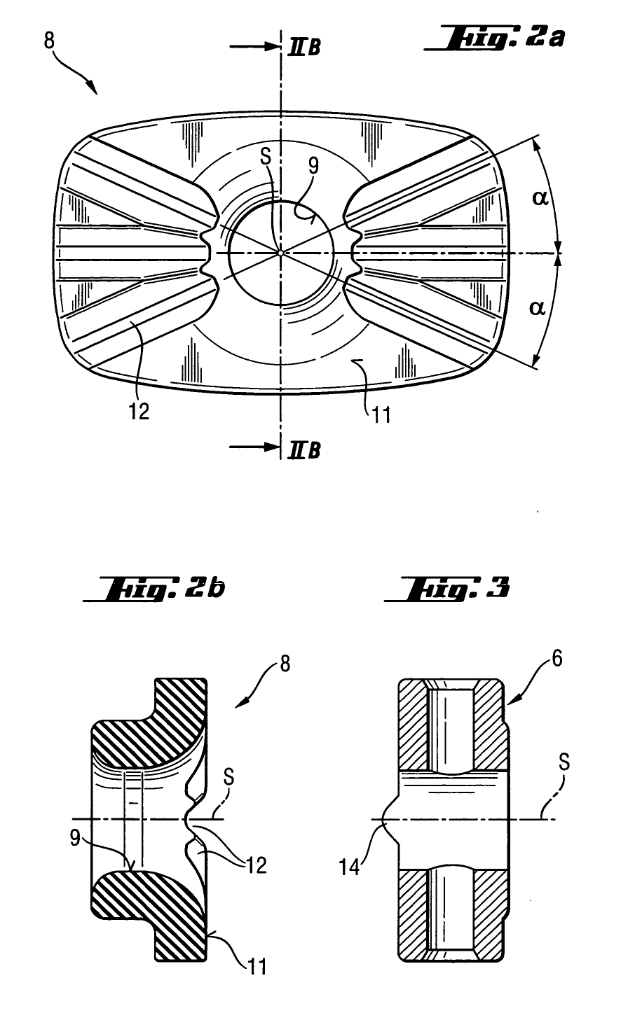

As shown in FIGS. 2a and 2b, in the cylindrical surface 9 adjoining the slide flange surface 11, there are formed three stop recesses 12 in form of an inner wedge groove. The longitudinal direction of the inner wedge groove extends through the pivot axis S, and the inner wedge grooves extend relative to each other at an angle α of 25°.

According to FIG. 3, in the stirrup arm 6 of the retaining stirrup 5, the stop means 14 is formed as a wedge-shaped projection 14 extending along the stirrup arm 6 in a direction of the associated slide flange surface 11 (FIGS. 2a, 2b).

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A chuck for a mechanized, at least partially percussively driven, along a percussion axis (A), percussion tool (2), comprising a tool guide (3); a retaining stirrup (5) having at least one stirrup arm (6); a drag bearing (7) for supporting the retaining stirrup (5) for a pivotal movement about a pivot axis (S) extending transverse to the percussion axis (A); and at least one elastomeric insert (B) provided between the tool guide (3) and the retaining stirrup (5).

2. A chuck according to claim 1, wherein the elastomeric insert (8) is formed of a material having a maximum of an imaginary component of a complex modules of elasticity in a temperature range between 0° C. and 70° C. and a frequency range between 1 Hz and 100 Hz.

3. A chuck according to claim 2, wherein the material the elastomeric insert (8) is formed of, is abrasion-proof and wear-resistant.

4. A chuck according to claim 1, wherein the elastomeric insert (8) forms an inner cylindrical surface (9).

5. A chuck according to claim 4, wherein the inner cylindrical surface (9) is formed within a flat slide flange surface (11) extending transverse to the pivot axis (s).

6. A chuck according to claim 5, wherein the at least one stirrup arm (6) is preloaded against the slide flange surface (11) under pressure.

7. A chuck according to claim 5, wherein at least one stop access (12) is formed in the slide flange surface (11).

8. A chuck according to claim 7, wherein the at least one stop recess (12) is formed as an elongate groove.

9. A chuck according to claim 8, wherein a further stop recess, which is formed as an elongate groove, is provided in the slide flange surface (11), and wherein the two elongate grooves are offset relative to each other in a longitudinal direction thereof by an angle (α) in a range between 20° and 70°.

10. A chuck according to claim 1, wherein stop means (14) is provided on the at least one stirrup arm (6).

11. A chuck according to claim 10, wherein the stop means (14) is formed as a bulge extending along the at least one stirrup arm (6) in a direction of the slide flange surface.

12. A chuck according to claim 1, wherein the retaining stirrup (5) has two stirrup arms (6) extending parallel to each other and spaced from each other, and wherein an elastomeric insert is associated with each of the stirrup arm.

13. A chuck according to claim 12, wherein the tool guide (3) has an elongate opening (13) extending along the percussion axis (A) for each of the two stirrup arms (6).
